(19) United States
(12) Patent Application Publication
(10) Pub. No.: US 2006/0194545 A1
(43) Pub. Date: Aug. 31, 2006

(54) Information processing apparatus and control method

(76) Inventor: Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/361,898

(22) Filed: Feb. 24, 2006

(30) Foreign Application Priority Data
Feb. 28, 2005 (JP) 2005-054792

(51) Int. Cl. H04B 17/00

(52) U.S. Cl. 455/67.13

(57) ABSTRACT

According to one embodiment, an information processing apparatus includes, a wireless communication device including a detector and a communication unit, and executing wireless communications with a base station using a wireless signal, a unit for determining whether or not a current position of the apparatus exists in a wireless service area covered by the station according to strength of the wireless signal detected by the detector, and a unit for changing a state of the device from a first state to a second state when the determining unit determines that the current position of the apparatus exists outside the area covered by the station, the first state corresponding to a state in which the detector and the communication unit are in an operating state, the second state corresponding to a state in which the communication unit is in an operation stop state and the detector is in an operating state.

### CROSS-REFERENCE TO RELATED APPLICATIONS

This application is based upon and claims the benefit of priority from Japanese Patent Application No. 2005-054792, filed Feb. 28, 2005, the entire contents of which are incorporated herein by reference.

### BACKGROUND

1. Field

One embodiment of the invention relates to an information processing apparatus such as a personal computer and, more particularly, to a wireless communication executable information processing apparatus, and to a control method used for the same apparatus.

2. Description of the Related Art

In recent years, various notebook personal computers having an institute of electrical and electronics engineers (IEEE) 802.11 standards (wireless local area network) corresponding to wireless communication device have been developed. This kind of computer executes a wireless connection (communication) with an external network such as the Internet when the computer exists in a public wireless LAN service area.

Recently, a computer having a function of reducing power consumption of a wireless communication device has been developed. For example, Japanese Patent Application KOKAI No. 8-307428 discloses a wireless transceiver having a low power consumption reception standby mode.

An information processing apparatus having a built-in wireless communication device functions as a mobile station. Thus, wireless communication environment is largely variable depending on the current position of the information processing apparatus. Specifically, if the information processing apparatus exists in a public wireless LAN service area, wireless communications are executable. However, if the information processing apparatus moves outside the public wireless LAN service area, wireless communications are not executable any longer.

Therefore, an information processing apparatus such as a portable computer has a need to manage the state of the wireless communication device in accordance with the current position of the information processing apparatus.

Moreover, the state of a required wireless communication device is different depending on the needs whether or not user requires wireless communications during movement.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the appearance of an information processing apparatus according to a first embodiment of the present invention;

FIG. 2 is an exemplary block diagram showing the system configuration of the information processing apparatus according to the first embodiment;

FIG. 3 is an exemplary block diagram showing the system configuration of a wireless communication device according to the first embodiment;

FIG. 4 is an exemplary block diagram showing the system configuration of a power saving utility executed by the information processing apparatus according to the first embodiment;

FIG. 5 is an exemplary view for explaining a power saving utility setup window display on a display screen of information processing apparatus according to the first embodiment;

FIG. 6 is an exemplary view for explaining a state transition of the wireless communication device managed according to according to the first embodiment;

FIG. 7 is an exemplary block diagram showing a first system configuration of the wireless LAN device according to a second embodiment of the invention; and

FIG. 8 is an exemplary block diagram showing a second system configuration of the wireless LAN device according to a third embodiment of the invention.

### DETAILED DESCRIPTION

Various embodiments according to the invention will be described hereinafter with reference to the accompanying drawings. In general, according to one embodiment of the invention, an information processing apparatus includes a wireless communication device including a signal detection unit detecting strength of a predetermined frequency wireless signal and a communication unit transmitting and receiving data using the wireless signal, and executing wireless communications with a base station using the predetermined frequency wireless signal, means for determining whether or not a current position of the information processing apparatus exists in a wireless service area covered by the base station in accordance with the strength of wireless signal detected by the signal detection unit, and means for changing a state of the wireless communication device from a first state to a second state in a case where the determining means determines that the current position of the information processing apparatus exists outside the wireless service area covered by the base station, the first state corresponding to a state in which the signal detection unit and the communication unit are in an operating state, the second state corresponding to a state in which the communication unit is in an operation stop state and the signal detection unit is in an operating state.

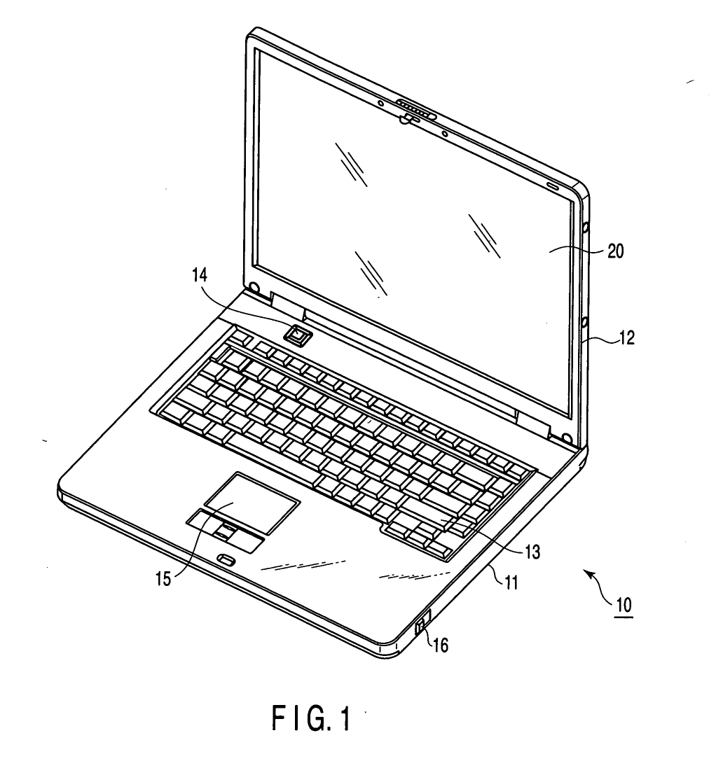

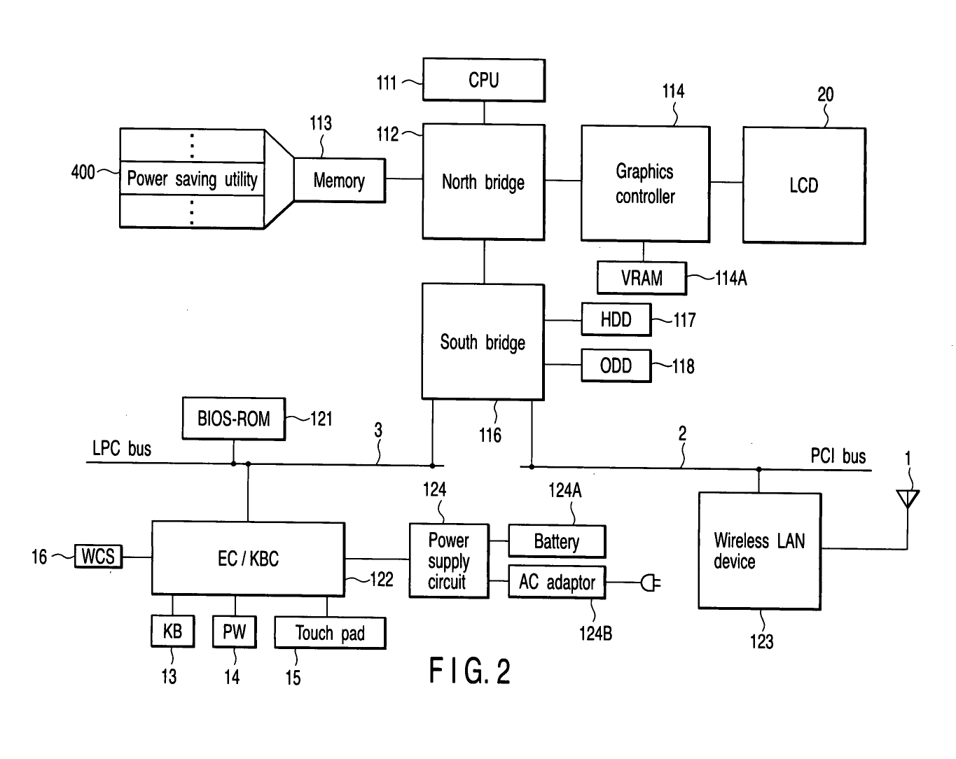

The configuration of an information processing apparatus according to one embodiment of the present invention will be described below with reference to FIG. 1 and FIG. 2. The information processing apparatus is a notebook type information processing apparatus, and realized as a notebook personal computer 10.

FIG. 1 is a perspective view showing a state that a display unit of the notebook personal computer 10 is opened. The computer 10 is composed of computer body 11 and display unit 12. The display unit 12 has a built-in display device comprising a liquid crystal display (LCD) 20. A display screen of the LCD 20 is located on substantially a center of the display unit 12.

The display unit 12 is supported on the computer body 11, and relatable attached between a closed position with the upper surface of computer main body 11 is covered and a release position with respect to the computer body 11. The computer body 11 has a thin box-type casing, and the upper surface is provided with a keyboard 13, a power button for powering on/off the computer 10, and a touch pad 15. The computer body 11 is further provided with a wireless communication switch 16.

The computer 10 has a built-in wireless local area network (LAN) device as a wireless communication device. The wireless LAN device executes wireless communications with a public wireless LAN service area provided via a wireless LAN access point (base station).

The wireless communication switch 16 is an operation switch for powering on/off the wireless LAN device built in the computer 10. The wireless communication switch 16 is a two-state switch having the following two states. One is an on state of instructing to power on the wireless LAN device, and another is an off state of instructing to power off the wireless LAN device. When user sets the wireless communication switch 16 to the on state, the wireless LAN device is powered on. Conversely, when user sets the wireless communication switch 16 to the off state, the wireless LAN device is powered off.

The computer 10 has a function of automatically changing the state of the wireless LAN device between a normally operating state and a search state. In this case, the state of the wireless LAN device is changed based on whether or not the computer 10 exists in the public wireless LAN service area covered by the wireless LAN access point (base station). The search state is a power consumption state lower than the normally operating state. In the search state, of various components included in the wireless LAN device, only signal detection unit for detecting strength of a wireless signal from the wireless LAN access point operates while the operation of other components is stopped.

Moreover, the computer 10 changes the state of the wireless LAN device in accordance with a request from user. Specifically, the computer 10 has the following four modes as a mode for controlling the wireless LAN device, that is, “normally on mode”, “search mode”, “normally off mode” and “auto power saving mode”. Thus, user can select one of the foregoing four modes.

When user selects the “normally on mode”, the wireless communication device is set to a normally operating state. In the normally operating state, both communication unit and signal detection unit provided in the wireless communication device are basically set to an operating state. When user selects the “search mode”, the wireless communication device is set to a search state. When user selects the “normally off mode”, the wireless communication device is set to an off state. In the foregoing off state, both communication unit and signal detection unit provided in the wireless communication device are set to a power-off state. The foregoing “auto power saving mode” is an operating mode of automatically changing the wireless LAN device between the normally operating state and the search state.

The foregoing four operating modes are selectively realized according to a power saving utility program, which is given as software for managing power consumption of the wireless LAN device. When being booted in the power saving utility program, the power saving utility program displays a setup window for specifying the operating mode of the wireless LAN device by user on the LCD 20. The power saving utility program controls the state of the wireless LAN device in accordance with a user's input operation executes on the setup window.

The system configuration of the computer 10 will be described below with reference to FIG. 2.

The computer 10 includes a CPU 111, a north bridge 112, a main memory 113, a graphics controller 114, the LCD 20, a south bridge 116, a hard disk drive (HDD) 117, and an optical disk drive (ODD) 118. The computer 10 further includes a BIOS-ROM 121, an embedded controller/keyboard controller IC (EC/KBC) 122, a wireless LAN device 123, and a power supply circuit 124.

The CPU 111 is a processor for controlling the operation of various components of the computer 10. The CPU 111 executes an operating system and various application programs loaded to the main memory 113 or HDD 117. The CPU 111 executes the foregoing power saving program 400 and wireless LAN driver for controlling the wireless LAN device 123. The CPU 111 executes a system basic input output system (BIOS) stored in the BIOS-ROM 121. The system BIOS is a program used for controlling hardware.

The north bridge 112 is a bridge device for connecting between a local bus of the CPU 111 and the south bridge 116. The north bridge 112 has a function of executing communications with the graphics controller 114 via an accelerated graphics port (AGP) bus.

The graphics controller 114 is a display controller for controlling the LCD 20 used as a display monitor of the computer 10. The graphics controller 114 control to display data stored in a video memory (VRAM) 114A on the LCD 20. Moreover, the graphics controller 114 generates a display signal to be transmitted to the LCD 20 on the basis of video data written in the VRAM 114A. The south bridge 116 has a built-in an integrated drive electronics (IDE) controller for controlling the HDD 117 and the ODD 118. The south bridge 116 connects various devices via peripheral component interconnect (PCI) bus 2 and a low pin count (LPC) bus 3. The PCI bus 2 is connected with the wireless LAN device 123. The LPC bus 3 is connected with the BIOS-ROM 121 and EC/KBC 122.

The HDD 117 is a storage device storing various software and data. The ODD 118 is a drive unit for driving storage medium such as a digital versatile disc (DVD) and a compact disc (CD).

The EC/KBC 122 is a one-chip microcomputer, which integrated with embedded controller for power management and keyboard controller for controlling a keyboard (KB) 13, a power button 14 and a touch pad 15. Moreover, the EC/KBC 122 has a function of controlling the wireless communication switch (WCS) 16. The power supply circuit 124 is connected with a battery 124A and a AC adaptor 124B.

The EC/KBC 122 has a function of operating in cooperation with the power supply circuit 124, thereby powering on/off the computer 10 in accordance with user operation of the power button 14. The power supply circuit 124 generates a system power to be supplied to various components of the computer 10 using external power supplied via the AC adaptor 124B or power from the battery 124A.

The wireless LAN device 123 is a wireless communication device complying to an institute of electrical and electronics engineers (IEEE) 802.11 standards, for example. The wireless LAN device 123 executes wireless communications with the wireless LAN service area access point using a wireless signal having a frequency band such as 2.4 GHz industrial scientific and medical (ISM) band.

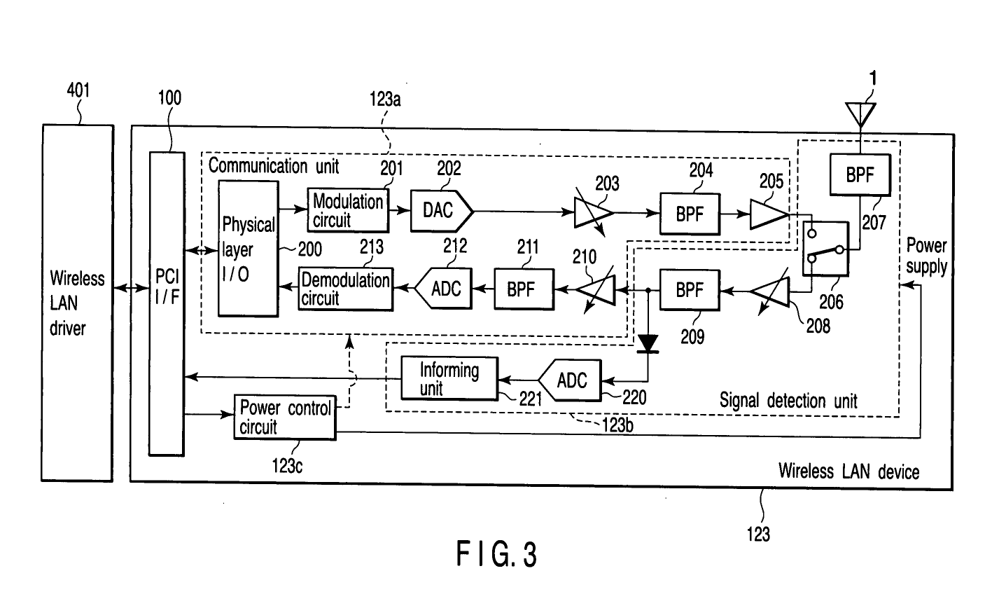

The configuration of the wireless LAN device will be described below with reference to FIG. 3.

The wireless LAN device 123 includes a PCI interface 100, a communication unit 123a, a signal detection unit 123b and a power control circuit 123c. The PCI interface 100 is an interface connecting the wireless LAN device 123 to the PCI bus 2.

The communication unit 123a functions a unit for executing a data exchange using a wireless signal. The communication unit 123a includes a physical layer input/output (I/O) device 200, a modulation circuit 201 and a digital-to-analog converter (DAC) 202. The communication unit 123a further includes a power amplifiers 203, 205, 210, a band pass filters (BPF) 204, 211, an analog-to-digital converter (ADC) 212 and demodulation circuit 213.

The signal detection unit 123b functions as a unit for detecting strength of a wireless signal from an access point. The signal detection unit 123b includes a switch 206, a band pass filters 207, 209, a power amplifier 208, an analog-to-digital converter (ADC) 220 and informing unit 221. The informing unit 221 has a function of informing the CPU 111 of strength (electric field strength) of a wireless signal received via the antenna 1.

In the wireless LAN device 123, the modulation circuit 201, the digital-to-analog converter 202, the power amplifiers 203, 205 and the band pass filter 204 are equivalent to a transmitter transmitting data. Moreover, in the wireless LAN device 123, an amplifiers 208, 210, a band pass filters 209, 211, a modulation circuit 201, an analog-to-digital converter 212 and a demodulation circuit 213 are equivalent to a receiver receiving a wireless signal. The power amplifiers 208 and the band pass filter 209 of the receiver have a function of detecting a signal level of the wireless signal received via the antenna 1. Therefore, these power amplifiers 208 and the band pass filter 209 are shared between the communication unit 123a and the signal detection unit 123b.

Data to be sent is inputted to the modulation circuit 201 via a PCI interface 100 and a physical layer I/O device 200, and then, modulated therein. A signal obtained from the modulation circuit 201 is externally transmitted via the digital-to-analog converter (DAC) 202, the power amplifier 203, the band pass filter (BPF) 204, the power amplifier 205, the switch 206, the band pass filter 207 and the antenna 1.

The wireless signal from the wireless LAN access point received via the antenna 1 is inputted to the demodulation circuit 213 via the following path, and then, demodulated therein. Specifically, the wireless signal is supplied via the band pass filter 207, the switch 206, the power amplifier 208, the band pass filter 209, the power amplifier 210, the band pass filter 211 and the analog-to-digital converter (ADC) 212. The signal obtained by the demodulation circuit 213 is supplied to the CPU 111 via the physical layer I/O device 200 and the PCI interface 100.

On the other hand, a 2.4 GHz band signal extracted by the band pass filter 209 is inputted to the analog-to-digital converter 220 via a rectifier diode, and then, converted into a digital signal therein. The signal obtained by the analog-to-digital converter 220 is inputted to the informing unit 221. Information showing strength of the wireless signal received via the antenna 1 is supplied to a wireless LAN driver 401 via the PCI interface 100.

The power control circuit 123c controls each power supply to communication unit 123a and signal detection unit 123b independently according to a command from the wireless LAN driver 401.

A first power saving function of the embodiment will be explained below.

(1) Search State

When user specifies the “search mode”, the power control circuit 123c supplies power to only signal detection unit 123b under control of the wireless LAN driver 401. In the search state, the communication unit 123a is set to a power-off state (operation stop state); on the other hand, the signal detection unit 123b is set to a power-on state (operating state). Thus, the signal detection unit 123b receives a wireless signal via the antenna 1, and gives a level of the received signal to the wireless LAN driver 401 (i.e., CPU 111) via the PCI interface 100. The wireless LAN driver 401 has a function of determining whether or not the current position of the computer 10 exists in a wireless service area in accordance with the received signal level,

(2) Normally Operating State

When user specifies the “normally on mode”, the power control circuit 123c supplies power to the communication unit 123a of the wireless LAN device 123 and the signal detection unit 123b under control of the wireless LAN driver 401. In the normally operation state, the communication unit 123a and the signal detection unit 123b are set to a power-on state (operating state). Moreover, In the normally state, the power control circuit 123c at least supplies power to the communication unit 123a of the wireless LAN device 123 and the signal detection unit 123b respectively are set to a power-on state (operating state) under control of the wireless LAN driver 401. In the normally operation state, the wireless LAN driver 401 executes wireless communications with an access point. Moreover, the wireless LAN driver 401 determines whether or not the current position of the computer 10 exists in a wireless service area in accordance with the given received signal level.

(3) Off State

When user specifies the “normally off mode”, the power control circuit 123c cut off the power supply to the communication unit 123a of the wireless LAN device 123 and the signal detection unit 123b under control of the wireless LAN driver 401. In the off state, the communication unit 123a and the signal detection unit 123b are set to a power-off state (operation stop state).

(4) Auto Power Saving Mode

When user specifies the “auto power saving mode”, the wireless LAN driver 401 determines whether or not the current position of the computer 10 exists in a wireless service area covered by the access point in accordance with the received signal level given from the signal detection unit 123b. According to the determined result, the wireless LAN driver 401 controls the power control circuit 123c. Hereby, the state of the wireless LAN device 123 is automatically changed between the normally operating state and the search state.

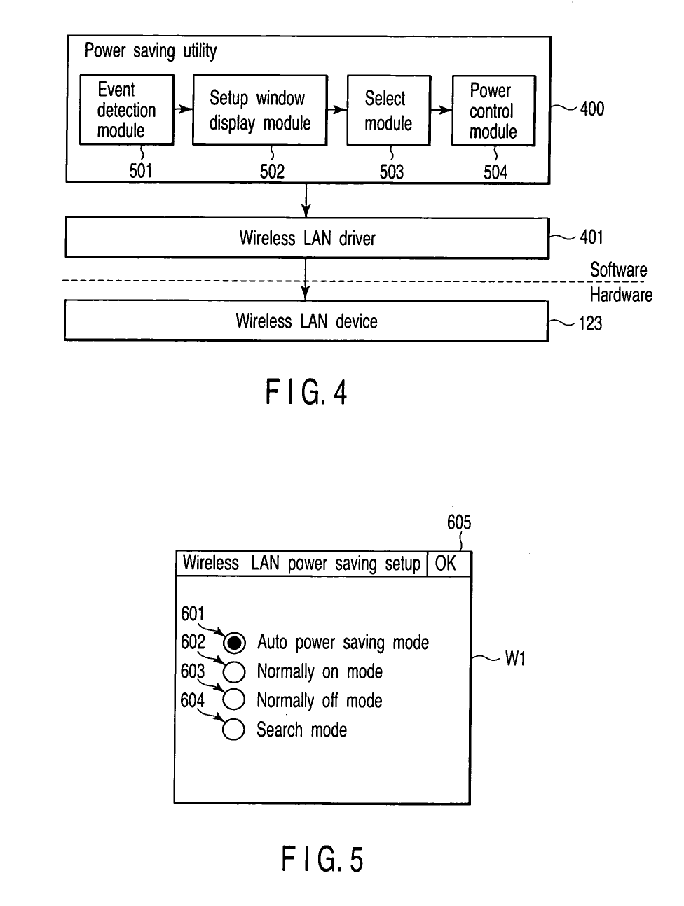

The functional configuration of the power saving utility program 400 will be explained below with reference to FIG. 4.

The power saving utility program 400 includes an event detection module 501, a setup window display module 502, a select module 503 and a power control module 504.

The event detection module 501 detects a generation of an event showing that user operates a predetermined key on the keyboard 13. The setup window display module 502 displays the setup window on the LCD 20 when the event detection module 501 executes detection that the predetermined key on the keyboard 13 is operated. The select module 503 selects one of “normally on mode”, “search mode”, “normally off mode” and “auto power saving mode” in accordance with user's input operation on the setup window. As described above, “normally on mode”, “search mode” and “normally off mode” correspond to normally operating state, search state and off state, respectively.

The select module 503 retains the selected operating mode of the wireless LAN device 123 as state specified information. The power control module 504 controls the power control circuit 123c of the wireless LAN device 123 in accordance with the selected operating mode via the wireless LAN driver 401.

In FIG. 5, there is shown a setup window W1 display of example display screen of the LCD 20 by the power saving utility program 400.

The setup window W1 is used as a graphical user interface (GUI) for specifying the operating mode of the wireless LAN device 123 by user. The setup window W1 displays a radio buttons 601, 602, 603, 604 and a “OK” button 605.

The radio button 601 is used for specifying the “auto power saving mode”. The radio button 602 is used for specifying the “normally on mode”. The radio button 603 is used for specifying the “normally off mode”. The radio button 604 is used for specifying the “search mode”.

When user presses the “OK” button 605, an operating mode corresponding to the currently selected radio button is selected on the display screen of the setup window W1.

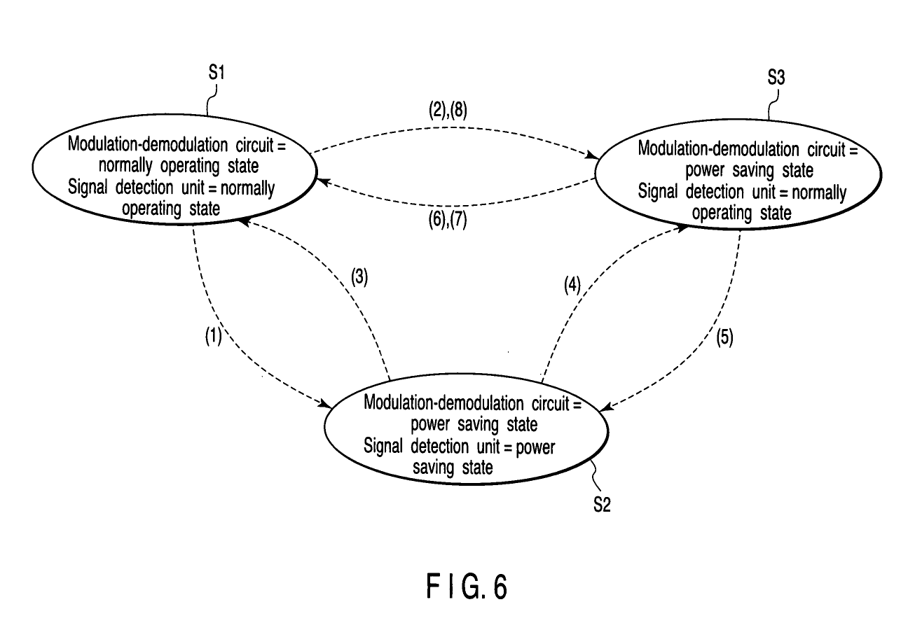

The state transition of the wireless LAN device 123 will be explained below with reference to FIG. 6.

A state S1 shows normally operating state. In the state S1, the communication unit 123a is in a normally operating state, that is, power-on state while the signal detection unit 123b is in a normally operating state, that is, power-on state. A state S2 shows the off state. In the state S2, the communication unit 123a is in a power saving state, that is, operation stop state while the signal detection unit 123b is in a power saving state, that is, operation stop state. A state S3 shows the search state. In the state S3, the communication unit 123a is in a power saving state, that is, operation stop state while the signal detection unit is in a normally operating state, that is, power-on state.

Now, if the current state is in the state S1. In this case, if an event (1) that the “normally off mode” corresponding to the radio button 603 is operated on the display screen of the setup window W1 is generated, the current state is changed from the state S1 to the state S2. That is, the current state returns from the state S2 to the state S1 according to the generation of event (3) under of control of the wireless LAN driver 401.

If an event (2) that the “search mode” corresponding to the radio button 604 is operated on the display screen of the setup window W1 is generated, the current state is changed from the state S1 to the state S3.

Now, if the current state is the state S2. In this case, if an event (3) that the “normally on mode” corresponding to the radio button 602 is operated on the display screen of the setup window W1 is generated, the current state is changed from the state S2 to the state S1. If an event (4) that the “search mode” corresponding to the radio button 604 is operated on the display screen of the setup window W1 is generated, the current state is changed from the state S2 to the state S3.

Now, if the current state is the state S3. In this case, if an event (5) that the “normally off mode” corresponding to the radio button 603 is operated on the display screen of the setup window W1 is generated, the current state is changed from the state S3 to the state S2. If an event (6) that the “normally on” corresponding to the radio button 602 is operated on the display screen of the setup window W1 is generated, the current state is changed from the state S3 to the state S1.

User sets the “auto power saving mode” on the display screen of the setup window W1. For example, in the state S3, if an event (7) that the signal detection unit 123b detects a received signal level more than a predetermined value, the current state is changed from state S3 to the state S1. Moreover, in the state S1, if an event (8) that no received signal level more than the predetermined value is detected by the signal detection unit 123b, the current state is changed from state S1 to the state S3.

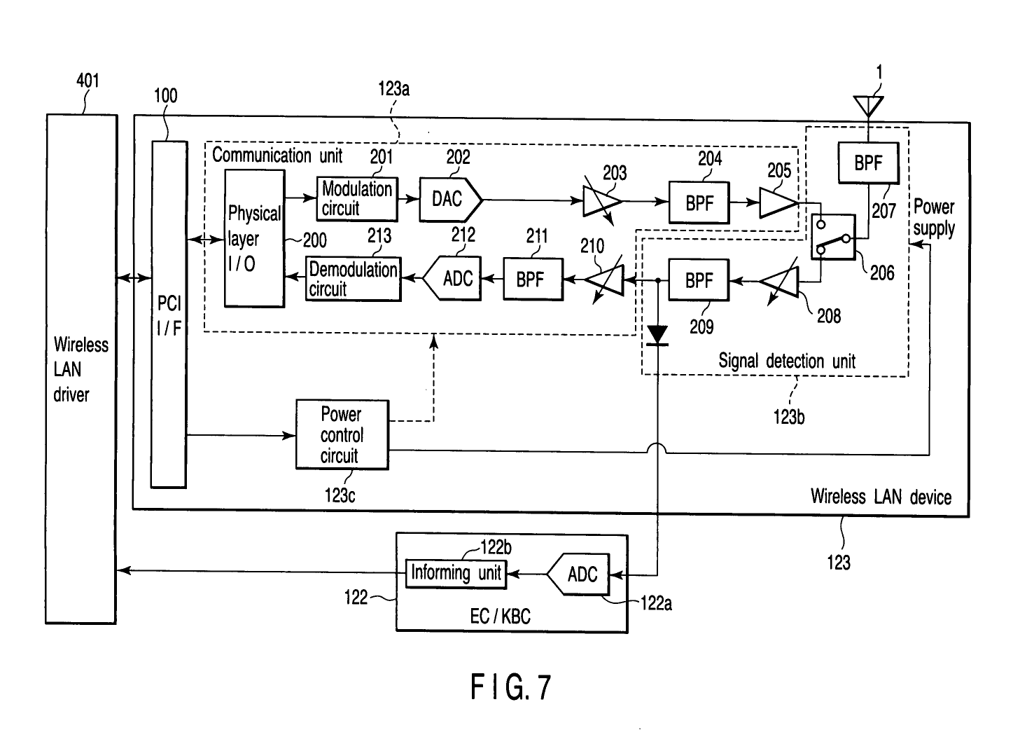

A second system configuration of the wireless LAN device 123 will be explained below with reference to FIG. 7. In FIG. 7, the same reference numerals are used to designate components identical to FIG. 3.

The EC/KBC 122 includes the analog-to-digital converter (ADC) 122a and informing unit 122b. The analog-to-digital converter (ADC) 122a converts a signal obtained via the band pass filter 209 into a digital signal. A (digital) signal obtained by the analog-to-digital converter 122a is inputted to the informing unit 122b. The informing unit 122b has a function correspond to the informing unit 221 of FIG. 3.

When being supplied with power the signal detection unit 123b, the signal detection unit 123b receives a wireless signal via the antenna 1. The signal strength of the wireless signal inputted from the signal detection unit 123b to the informing unit 122b is given to the wireless LAN driver 401 (i.e., CPU 111). In other words, according to the configuration of FIG. 7, the EC/KBC 122 is provided with the informing unit for giving the detected received signal level to the CPU 111.

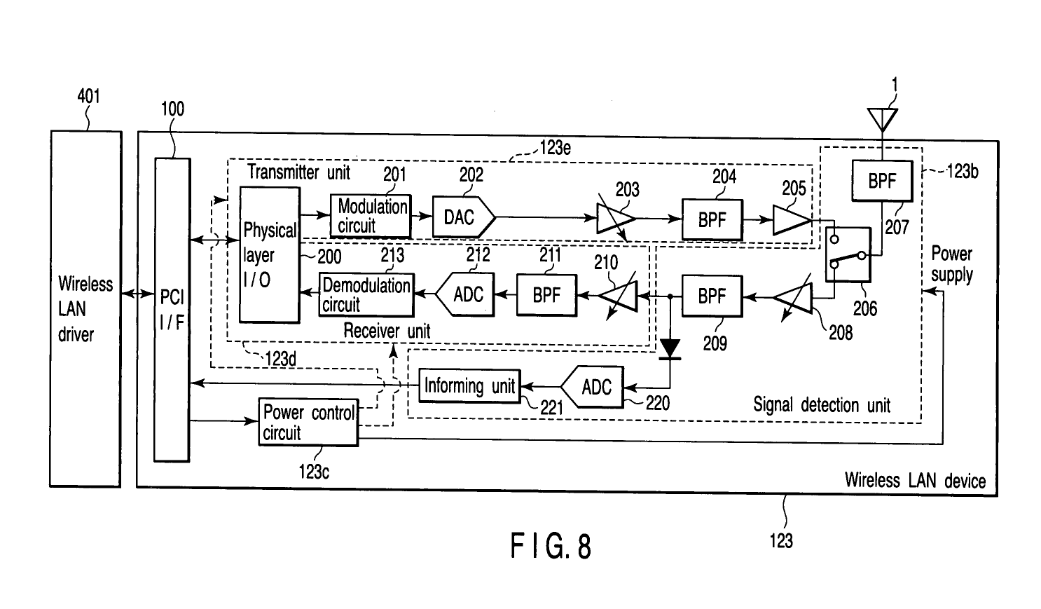

A third system configuration of the wireless LAN device 123 will be explained below with reference to FIG. 8. In FIG. 8, the same reference numerals are used to designate components identical to FIG. 3.

In the wireless LAN device 123 of FIG. 8, the communication unit 123a of FIG. 3 is divided into two circuits, that is, a transmitter 123e and a receiver 123d. The power control circuit 123c independently controls the power supply to each of a transmitter 123e, a receiver 123d and a signal detection unit 123b. Hereby, in the normally operating state, the transmitter 123e is not set to a power-on state (operating state), but power is supplied to the transmitter 123e so that the transmitter 123e is set to a power-on state (operating state) only when data transmission is necessary.

According to the embodiment, the state of the wireless LAN device 123 is automatically controlled in accordance with condition whether the current position of the computer exists inside or outside the public wireless LAN service area. Moreover, user uses the power saving utility, thereby setting the wireless LAN device 123 to a desired arbitrary state.

In the embodiment, the power-off state is used as the operation stop state. In this case, the supply of a clock signal may be stopped in place of stopping the power supply.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus capable of executing wireless communication, comprising:
a wireless communication device including a signal detection unit detecting strength of a predetermined frequency wireless signal and a communication unit transmitting and receiving data using the wireless signal, and executing wireless communications with a base station using the predetermined frequency wireless signal;
means for determining whether or not a current position of the information processing apparatus exists in a wireless service area covered by the base station in accordance with the strength of wireless signal detected by the signal detection unit; and
means for changing a state of the wireless communication device from a first state to a second state in a case where the determining means determines that the current position of the information processing apparatus exists outside the wireless service area covered by the base station, the first state corresponding to a state in which the signal detection unit and the communication unit are in an operating state, the second state corresponding to a state in which the communication unit is in an operation stop state and the signal detection unit is in an operating state.

2. The apparatus according to claim 1, wherein the changing means includes means for returning the state of the wireless communication device to the first state from the second state in a case where the determining means determines that the current position of the information processing apparatus exists in the wireless service area in a state that the wireless communication device is in the second state.

3. The apparatus according to claim 1, wherein the communication unit includes a signal processing unit receiving the wireless signal and a modulation unit modulating the wireless signal received by the signal processing unit, and a transmitter,
the signal detection unit functions as a detector detecting strength of the wireless signal received by the signal processing unit, and
the changing means includes means for stopping each operation of the transmitter and the modulation unit of the receiver in a state that the signal processing unit and the signal detection unit are kept in an operating state to change the state of the wireless communication device from the first state to the second state in a case where the determining means determines that the current position of the information processing apparatus does not exist in the wireless service area covered by the base station.

4. The apparatus according to claim 1, further comprising means for changing the state of the wireless communication device from one of the first and second states to a third state that the communication unit and the signal detection unit are in an operation stop state.

5. The apparatus according to claim 1, wherein the communication unit includes a receiver and a transmitter, and the first state includes a state that at least the signal detection unit and the receiver of the communication-unit are an operating state.

6. The apparatus according to claim 1, further comprising:
means for inputting a state specifying information for specifying one of the first state, the second state and a third state that the communication unit and the signal detection unit are an operating state; and
means for setting the state of the wireless communication device to one of the first state, the second state and the third state, which is specified by the inputted state specifying information.

7. A method of controlling an operation of a wireless communication device included in an information processing apparatus, the wireless communication device including a signal detection unit detecting strength of a predetermined frequency wireless signal and a communication unit transmitting and receiving data using the wireless signal, the method comprising:
executing wireless communications with a base station using the predetermined frequency wireless signal by the wireless communication device;
determining whether or not a current position of the information processing apparatus exists in a wireless service area covered by the base station in accordance with the strength of wireless signal detected by the signal detection unit; and
changing a state of the wireless communication device from a first state to a second state in a case where a determination result indicates that the current position of the information processing apparatus exists outside the wireless service area covered by the base station, the first state corresponding to a state in which the signal detection unit and the communication unit are in an operating state, the second state corresponding to a state in which the communication unit is in an operation stop state and the signal detection unit is in an operating state.

8. The method according to claim 7, further comprising, returning the state of the wireless communication device to the first state from the second state in a case where the determining result indicates that the current position of the information processing apparatus exists in the wireless service area in a state that the wireless communication device is in the second state.

9. The method according to claim 7, further comprising changing the state of the wireless communication device from one of the first and second states to a third state that the communication unit and the signal detection unit are in an operation stop state.

10. The method according to claim 7, further comprising:
specifying one of the first state, the second state and a third state that the communication unit and the signal detection unit are powered off; and
setting the state of the wireless communication device to the specified one of the first, second and third states.
